(19) United States
(12) Patent Application Publication
(10) Pub. No.: US 2023/0281476 A1
(43) Pub. Date: Sep. 7, 2023

(54) OFFLOADING KNOWLEDGE BASE CREATION

(71) Applicants: Lemon Inc., Grand Cayman (KY); Beijing Youzhuju Network Technology Co., Ltd., Beijing (CN)

(72) Inventors: Viacheslav Dubeyko, Los Angeles, CA (US); Jian Wang, Beijing (CN)

(21) Appl. No.: 18/098,611

(22) Filed: Jan. 18, 2023

(51) Int. Cl. G06N 5/022; G06N 5/04

(52) U.S. Cl. CPC G06N 5/022; G06N 5/041

(57) ABSTRACT

The present disclosure describes techniques for offloading knowledge base creation into a storage space. A sequence of patterns in a data stream may be identified based on a time dimension of the data stream by data processing units (DPUs) without an initiation from a Central Processing Unit (CPU). The DPUs may be associated with the storage space. The DPUs may recognize a plurality of information contexts corresponding to the sequence of patterns based on analyzing neighboring patterns of any particular pattern in the sequence of patterns. The DPUs may determine causal relations among the sequence of patterns based on detecting repetitions of any pair of information contexts among the plurality of information contexts. The causal relations may comprise a plurality of reason-consequence pairs. Knowledge of causal relationships associated with the data stream may be used to predict future states of the data stream.

### BACKGROUND

Companies and/or individuals are increasingly utilizing and/or producing a large quantity of data. Such data may need to be collected and translated into usable information (e.g., processed). Improved techniques for data processing are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example framework for offloading data processing in accordance with the present disclosure.

FIG. 2 shows an example framework for offloading knowledge base creation in accordance with the present disclosure.

FIG. 3 shows an example diagram illustrating a time dimension in data space accordance with the present disclosure.

FIG. 4 shows an example diagram illustrating data patterns in accordance with the present disclosure.

FIG. 5 shows an example diagram illustrating an information context in accordance with the present disclosure.

FIG. 6 shows an example diagram illustrating pattern similarity in accordance with the present disclosure.

FIG. 7 shows an example diagram illustrating notion generalization in accordance with the present disclosure.

FIG. 8 shows an example diagram illustrating notions relation in accordance with the present disclosure.

FIG. 9 shows an example diagram illustrating causality relationship in accordance with the present disclosure.

FIG. 10 shows an example diagram illustrating reproducibility of causality in accordance with the present disclosure.

FIG. 11 an example diagram illustrating a time map of causality in accordance with the present disclosure.

FIG. 12 shows an example diagram illustrating a reproducible causality time map in accordance with the present disclosure.

FIG. 13 shows an example diagram illustrating generalization of a causality structure in accordance with the present disclosure.

FIG. 14 shows an example diagram illustrating causal relationship prediction in accordance with the present disclosure.

FIG. 15 shows an example architecture for pattern recognition in accordance with the present disclosure.

FIG. 16 shows an example framework for causality recognition in accordance with the present disclosure.

FIG. 17 shows an example diagram illustrating hypotheses generation in accordance with the present disclosure.

FIG. 18 shows an example diagram illustrating hypotheses checking in accordance with the present disclosure.

FIG. 19 shows an example process for offloading knowledge base creation in accordance with the present disclosure.

FIG. 20 shows an example process for offloading knowledge base creation in accordance with the present disclosure.

FIG. 21 shows an example process for offloading knowledge base creation in accordance with the present disclosure.

FIG. 22 shows an example process for offloading knowledge base creation in accordance with the present disclosure.

FIG. 23 shows an example process for offloading data processing and knowledge synthesis in accordance with the present disclosure.

FIG. 24 shows an example computing device which may be used to perform any of the techniques disclosed herein.

### DETAILED DESCRIPTION OF ILLUSTRATIVE EMBODIMENTS

The central processing unit (CPU) based model of calculation represents one of the key obstacles to enhancing the performance of data processing (e.g., calculations). The CPU-based model of calculation requires moving data and/or code from persistent memory into dynamic random-access memory (DRAM), and from DRAM into one or more CPU cache(s). Calculation may be executed by means of sharing one or more CPU core(s) amongst multiple threads of execution. However, this computation paradigm introduces a significant number of drawbacks that prevent improved computation performance. For example, this computation paradigm may cause problems with cache coherence, memory wall, and data moving.

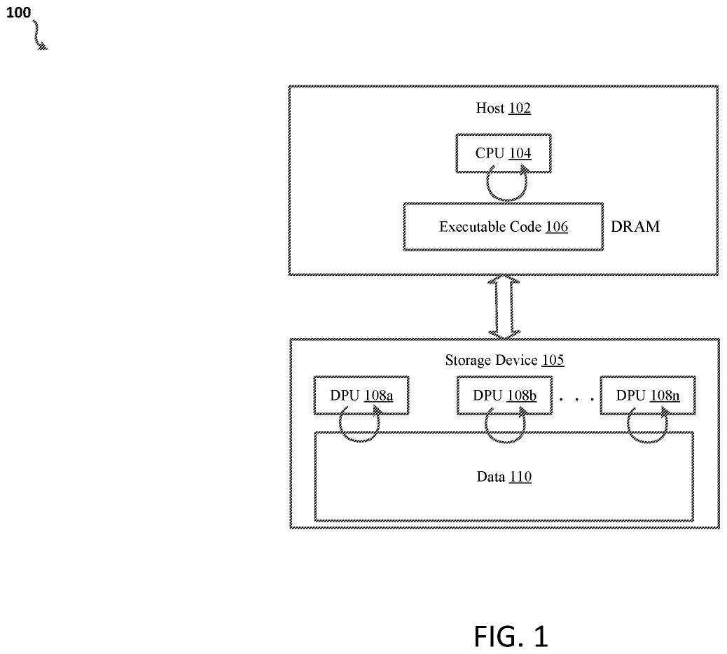

To address the drawbacks introduced by the CPU based model of calculation, computation may be offloaded into data storage space. FIG. 1 shows an example framework 100 for offloading data processing in accordance with the present disclosure. The framework 100 may comprise a host 102 and a storage device 105. The host 102 may comprise one or more CPUs (e.g., CPU cores) 104. The storage device 105 may comprise a plurality of data processing units (DPUs) 108a-n. Computational storage may process data 110 in the storage device 105, bypassing the CPU(s) 104. This approach may be difficult to implement in a CPU-centric or algorithm-based computing paradigm, as the CPU(s) 104 are the central point of algorithm execution and need to deliver the logic (e.g., executable code 106) of data processing from the host 102 into the storage device 105.

Any algorithm may be stored into persistent memory as an executable file. The logic of data processing may already be stored in the storage device 105 and the CPU(s) 104 may inform the plurality of DPUs 108a-n that file or executable image may be used to execute the processing of the data 110. The CPU(s) 104 and the plurality of DPUs 108a-n may represent different platforms (e.g., x86 and ARM, respectively) and the plurality of DPUs 108a-n may be unable to execute code that is built for the platform associated with the CPU(s) 104. In embodiments, it may be possible to compile code for the DPU platform and/or to use a just-in-time (JIT) compiler approach. In other embodiments, the logic of data processing may be implemented by means of FPGA-based cores. The CPU(s) 104 may need to start, manage, and/or orchestrate the activity of the plurality of DPUs 108a-n in the storage device 105. However, the CPU-centric computing paradigm may still introduce significant overhead and/or be a bottleneck even in the case of data-centric computing in the storage device 105. Thus, further improved techniques for data processing are desirable. Described herein are techniques configured to resolve the issues caused by the CPU-based model of computation for the case of data-centric computing in a storage space.

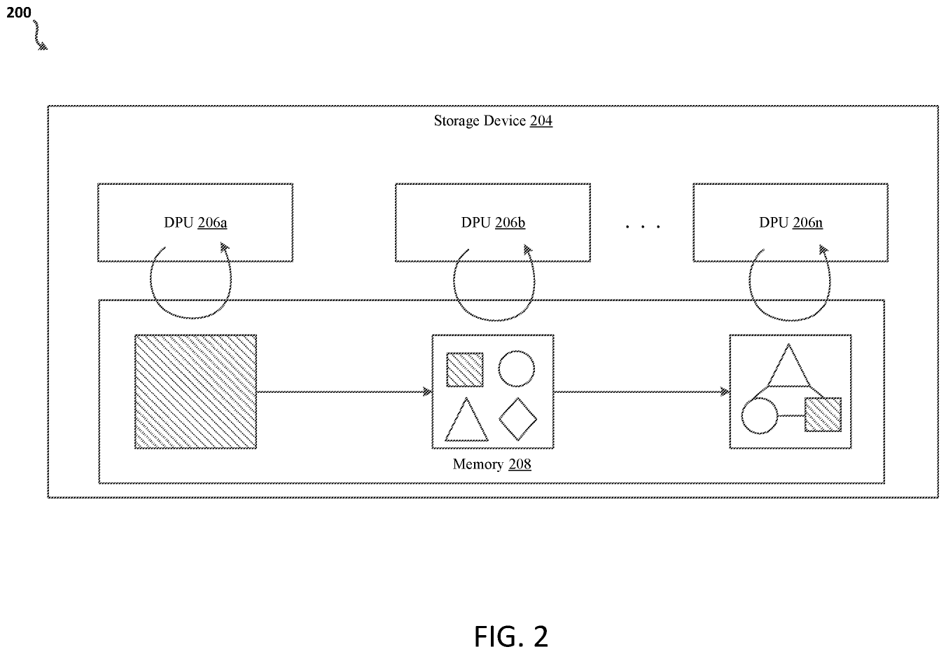

FIG. 2 shows an example framework 200 for offloading knowledge base creation in accordance with the present disclosure. The framework 200 may comprise a storage device 204. The storage device 204 may comprise a plurality of DPUs 206a-n and a memory 208. The storage device 204 may be a smart storage. A smart storage may be configured to recognize patterns in data and relations amongst the patterns without any instructions or management activity from a host side (e.g., from a CPU on the host side). A smart storage may be configured to build a knowledge base associated with the data and to share the knowledge in the knowledge base with the host.

As shown in the example of FIG. 2, the architecture of smart storage (e.g., storage device 204) comprises multi-core (the plurality of DPUs 206a) and a persistent memory space (e.g., memory 208). First, a host may be configured to store a raw binary data stream into the memory 208 of the storage device 204. The write operation may operate as the request for the storage device 204 to analyze and/or process data. Second, the storage device 204 may be configured to recognize patterns in the raw data stream. The storage device 204 may be configured to recognize patterns in the raw data stream in response to the host storing the raw data stream into the memory 208 of the storage device 204. For example, patterns in the raw data stream may be searched for using a binary neural network. Third, the storage device 204 may be configured to recognize relations amongst patterns in the data stream. Fourth, the storage device 204 may be configured to synthesize knowledge associated with the data stream into a knowledge base. The knowledge associated with the data stream may indicate the recognized patterns and the relations amongst the patterns. The DPU(s) 206a-n may be configured to utilize this knowledge base to execute computation by means of generalized requests represented by a set of data patterns. Fifth, the storage device 204 may be configured to share or expose the knowledge to the host.

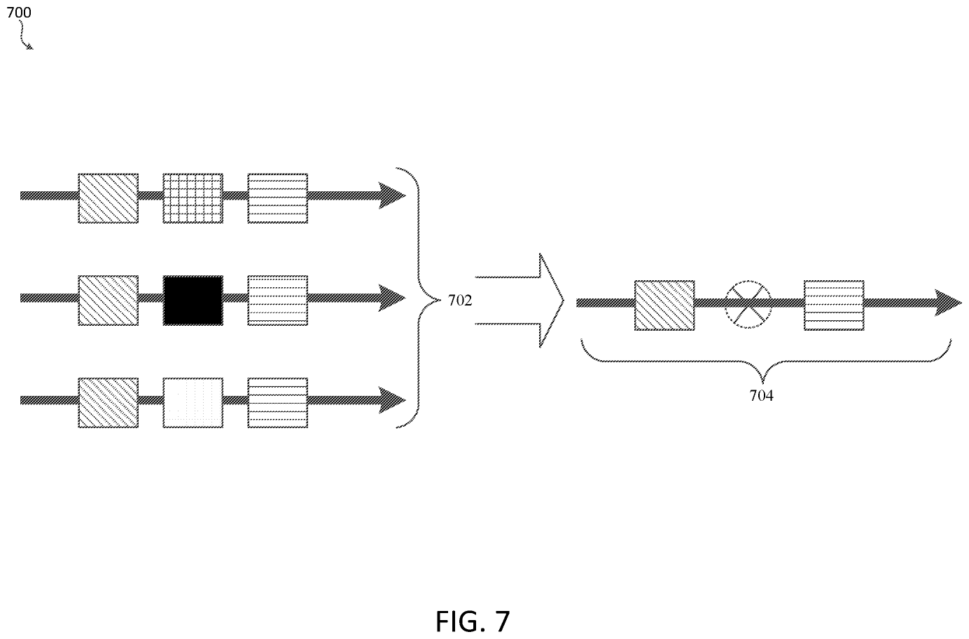

The storage device 204 may not need any algorithm or management from the host side during the building of the knowledge base. The storage device 204 may share generalized notions with the host as knowledge. Thus, the host may request the execution of a generalized algorithm on generalized notions from the storage device 204. Generalized notions are discussed below in more detail with regard to FIG. 7. The real logic and particular data may be defined by the storage device 204 itself without any management from the host side.

The chronological ordering of data items is the fundamental nature of any data. If data loses its chronological ordering, then important knowledge about the data is lost. Relations and interactions of data items in the time dimension may represent the nature of reality. The evolution and nature of reality may be coded into the order and relations of data items, and chronology represents the evolution and nature of reality by means of the time dimension. Time may define what is possible and impossible in the scope of reality. Thus, the chronological ordering of data items shows the fundamental laws of reality. Any data analysis therefore requires consideration of the time dimension.

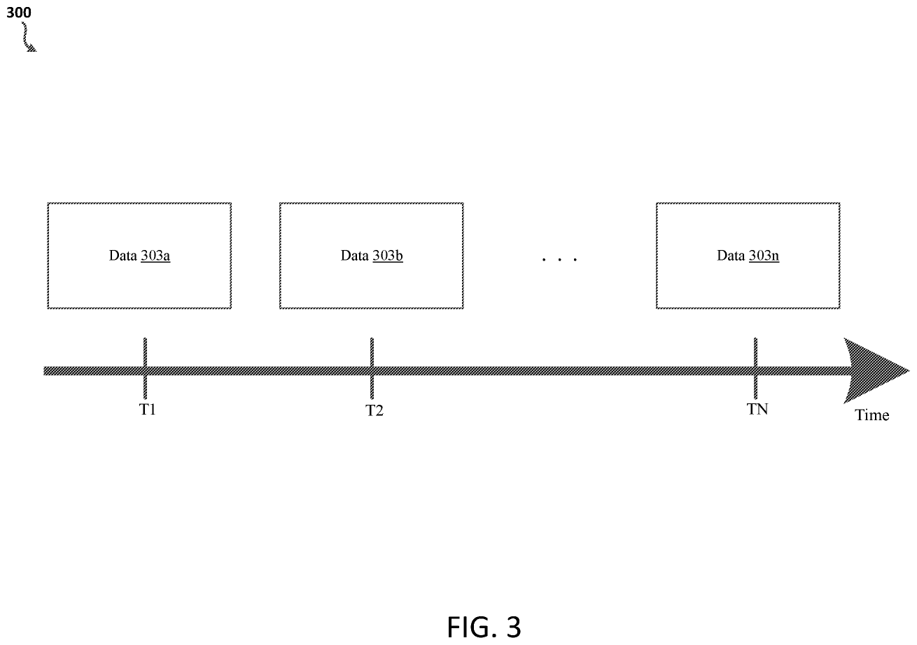

FIG. 3 shows an example diagram 300 illustrating a time dimension of data space in accordance with the present disclosure. In embodiments, data may comprise the output of sensors and/or a result of human interaction with a computer system. Thus, data may represent a binary stream distributed in time. The creation and gathering of data may occur inside of the time dimension, and data can be imagined like a stream. For example, the diagram 300 illustrates data 303a-n distributed in time. Collectively, the data 303a-n may represent a binary stream, with data 303a being created and/or gathered at a time T1 before data 303b was created and/or gathered at a time T2, and data 303b being created and/or gathered before data 303n was created and/or gathered at a time TN, and so on. Even existing data in persistent memory may be represented by a sequence of physical sectors, for example. The sequence of physical sectors may be imagined like a stream, with every part or sector of the stream corresponding to a particular timestamp. However, the physical sectors may not be ordered chronologically and may be randomly updated.

The reproducibility of data patterns is a fundamental foundation of coding the laws of reality. The detection of data pattern repeatability may facilitate the deduction of laws of physical reality. Data patterns' reproducibility in the input stream may be used to characterize the consistent patterns of the information dimension of reality. The time dimension is a fundamental data feature for implementing data analysis and data synthesis in neuromorphic computing. In particular, data ordering in time may be the basis to elaborate a vision of laws of information reality.

If a data stream has a high average data entropy, it may be impossible to detect the repeatability of data patterns in the data stream and/or that such repeatability of data patterns in the data stream could be a rare event. However, the repeatability of data patterns is the basis for understanding the laws of reality. Even considering an artificial system configured to generate data, it may not be possible to for the artificial system to generate data without pattern repetition. Digital data may be represented by a stream of bytes. Every byte can keep only 256 different states. Thus, any binary data stream bigger than a byte may be characterized by a high probability to discover the repeatability of data patterns in the data stream. Further, available digital data may be a representation of physical reality. Scientific methods of studying physical reality are grounded on the discovery of repeatable data patterns in the data stream as evidence of the laws of physical reality. Thus, this fundamental principle can be used by a neuromorphic computing system to process data without any algorithms provided by humankind.

Time is a space for processes evolution. The “infinity” or existential nature of time implies the inevitability of data patterns repetition, due to the finite nature of any complex system. Fundamentally, time is a space implementing patterns repeatability due to the infinite nature of time and the finite nature of complex systems. The repeatability of patterns is the side effect of the cyclicality of processes in complex systems. A complex system may own a set of states and interact with other complex systems of surrounding reality, thus enabling the change from one state into another. As a result, time creates the opportunity to detect the cyclicality of states in complex systems. Every new cycle may make a system even more complex and add a new set of states to the system. New states may repeat the abstract nature of initial states. Even new states of a more complex system may share similarities with patterns of initial system states.

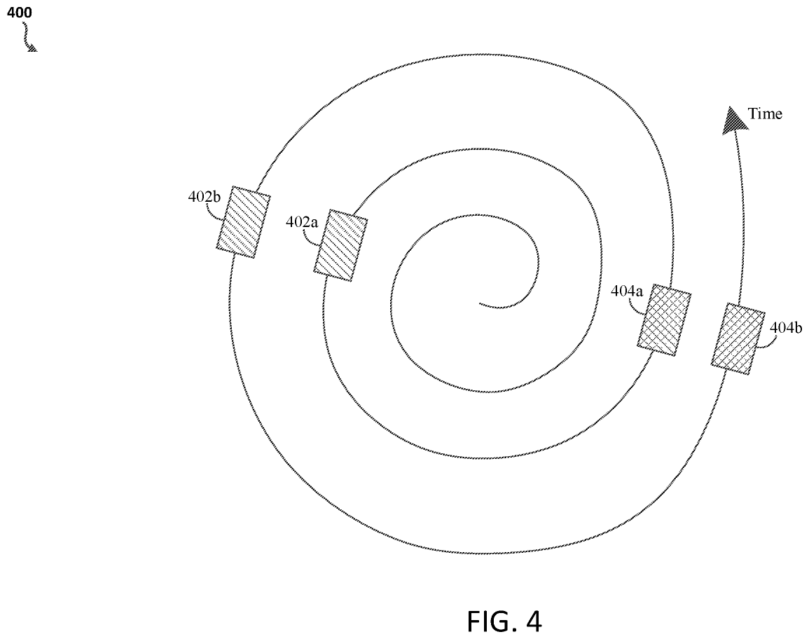

“Spiral history” may be considered a fundamental concept of any information system. FIG. 4 shows an example diagram 400 illustrating data patterns in accordance with the present disclosure. Spiral history represents the fundamental concept of information system evolution by increasing the complexity of system with time. Thus, a system may pass through a finite set of states, and states may repeat because of finite nature of any complex system. In the example of FIG. 4, the pattern 402a may repeat itself at a later point in time as pattern 402b, and pattern 404a may repeat itself at a later point in time as pattern 404b. Eventually, pattern 402b may repeat itself at a later point in time, and the pattern 404b may repeat itself at a later point in time. However, each repetition may not be a complete identity of states. Rather, each repetition may be a new state that is similar to a state that has already been registered in the past. For example, the pattern 402b may not be identical to the pattern 402a. Rather, the pattern 402b may be similar to (e.g., within a similarity threshold) to the pattern 402a. Every system may evolve to achieving a new quality of state. The new state may have a nature similar to the previous state. The spiral history concept may thus be the foundation to deduce knowledge on the basis of similarity and repetition of data patterns.

In embodiments, any data pattern may exist in the environment of adjacent data patterns, as any data stream is a sequence or a space that contains data patterns. A data pattern may exist in some information context. An information context is a structure composed of data patterns and the context determines the nature of a data pattern. In particular, the information context is the fundamental ground that may be used to generalize patterns into abstract notions.

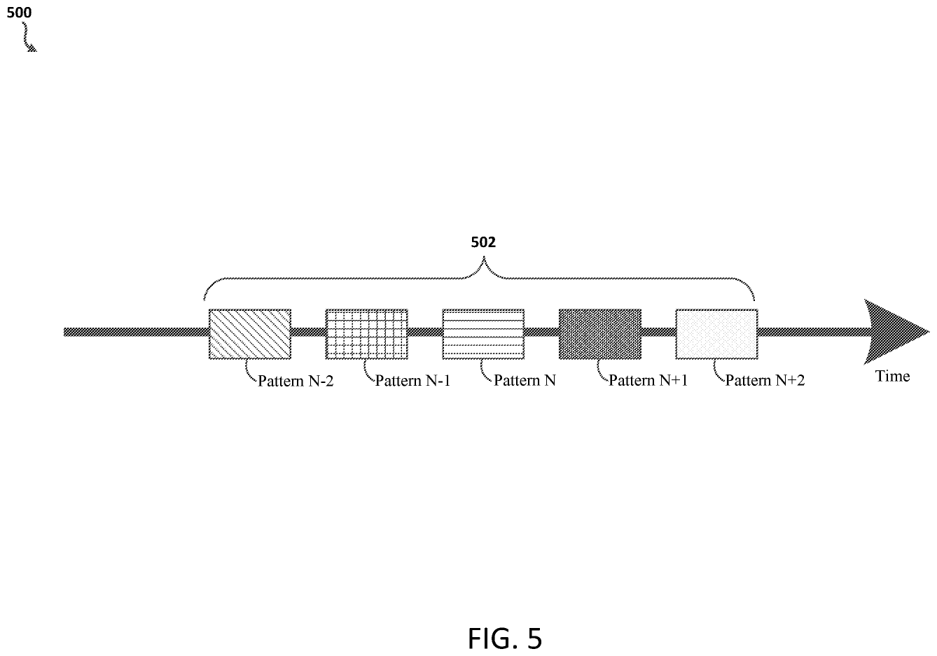

FIG. 5 shows an example diagram 500 illustrating an information context in accordance with the present disclosure. An information process can exist only in time. Time may define a sequence of data patterns in a data stream. The sequence of patterns may define a nature of an information process. The possibility or impossibility of the existence or order of data patterns in a complex data structure may define a consistent pattern and the nature of the complex structure existence.

A data pattern alone has no value or sense. The data pattern's context or relations with other patterns create value and sense. The information context associated with a data pattern provides value or sense to the data pattern. Various information contexts may even create different senses for the same data pattern. Thus, information contexts play a fundamental role in defining a pattern's meaning. The information context may provide the basis to discover the similarity of patterns and/or to deduce or generalize particular patterns to the abstract notion.

Any data stream represents a sequence of patterns. In the example of FIG. 5, a data stream may represent a sequence of patterns including the patterns N−2, N−1, N, N+1, and N+2. Any data pattern may have other data patterns nearby. For example, data pattern N in FIG. 5 has neighboring patterns N−2, N−1, N+1, and N+2. The neighboring patterns for a particular data pattern may create an information context for that particular data pattern. If it is possible to distinguish the neighboring patterns of a particular data pattern, then a set of the neighboring patterns may represent the information context at a particular position in the data stream. For example, the neighboring patterns N−2, N−1, N+1, and N+2 create the information context 502 for the data pattern N. The information context may define senses for all included data patterns. If any particular data pattern is selected in the stream, then the value and sense of this pattern may be detected by distinguishing the information context associated with the pattern. Distinguishing the information context associated with a data pattern may comprise recognizing neighboring patterns and finding a similarity with known information contexts. This technique may be referred to as the generalization technique of particular patterns to abstract ones.

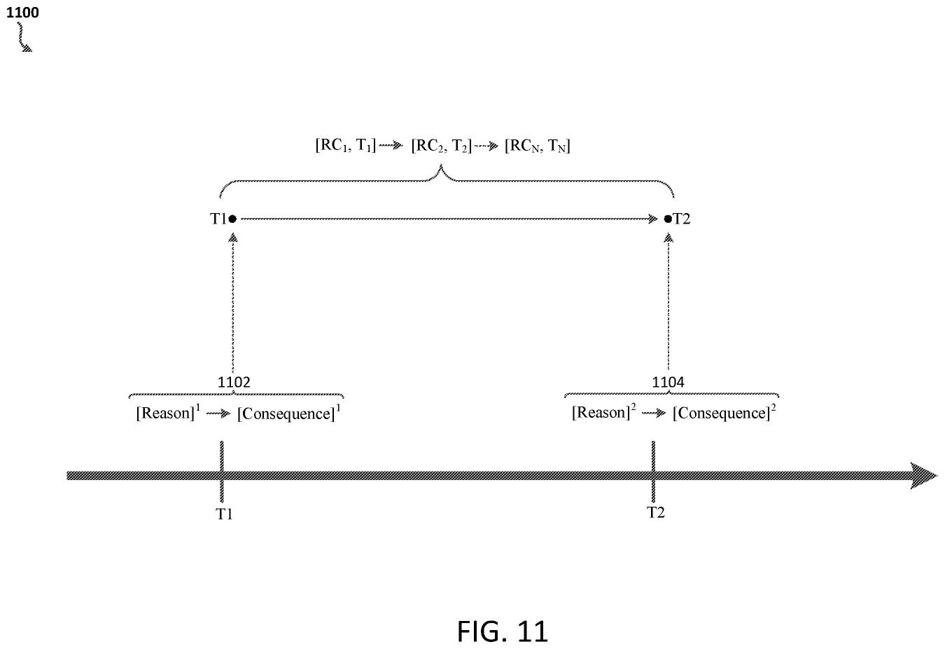

However, patterns in an information context do not represent an unordered set. Rather, the patterns in an information context form relationships with each other. The sequence and position of patterns in an information context may define the relation of patterns in the information context. Neighboring patterns may indicate a sense of a particular pattern in the information context. The reordering of patterns may change the meaning of every pattern in the information context. The information context may thus be the basis for building a graph or map that defines the relation of patterns in information context. Patterns may define the goal of a particular information context. Thus, the information context may prepare another information context in a sequence. The graph may be the mechanism that creates the technique to switch from one information context to another one. Such a graph is discussed in more detail below with regard to FIG. 11.

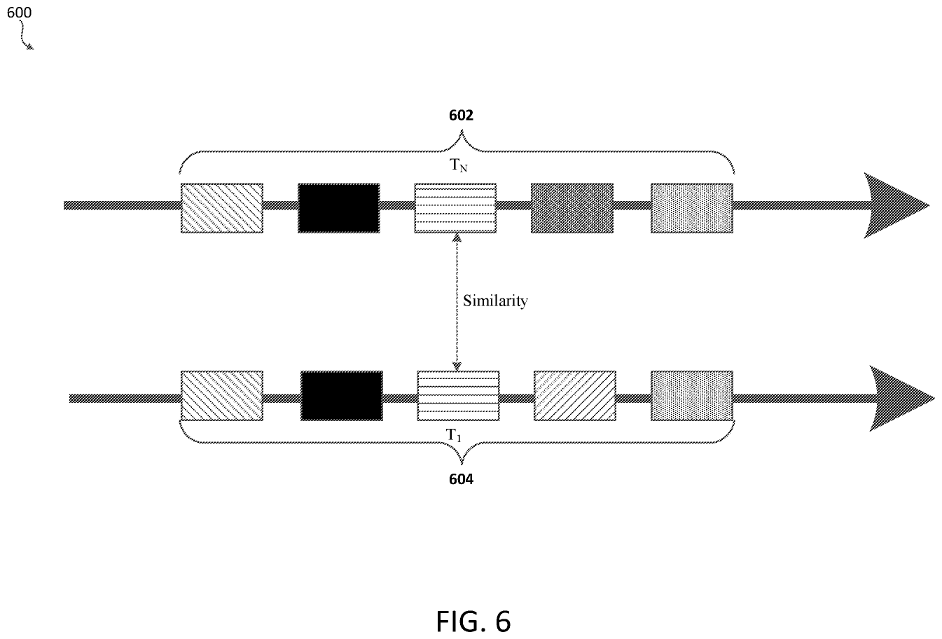

Two information contexts may be similar if a majority of patterns are identical between them. FIG. 6 shows an example diagram 600 illustrating pattern similarity in accordance with the present disclosure. A first information context 602 comprises a first set of patterns. A second information context comprises a second set of patterns. The first and second set of patterns may comprise one or more different patterns.

Any pattern may represent a byte stream of some length. It may be possible to detect the identity of byte streams by means of elementary byte streams comparison. Thus, any data stream may be imagined as a sequence of patterns distributed in time. The identity of patterns may be determined by comparing binary streams at different points in time. One or more of a neural network, an interconnection network, and/or any other software or hardware implemented algorithms may be utilized to detect the identity of patterns in a byte stream. As described above, the meaning of a pattern is defined the information context associated with that pattern. Thus, it is not enough only to detect the patterns' identities at different time points, but information contexts associated with the patterns also need to be distinguished.

First, the identity of the patterns in the data stream may be determined. Determining the identity of the patterns in the data stream may comprise identifying positions of the recognized patterns in the binary stream. Second, the information contexts may be determined based on the positions of the patterns. For example, the first information context 602 and the second information context 604 may be determined. As any information context is a sequence of patterns, information contexts can be compared with each other. Thus, the first information context 602 and the second information context 604 may be compared to each other to determine similarity between the first information context 602 and the second information context 604. This comparison operation may be executed by patterns comparison on different positions of the first information context 602 and the second information context 604.

Information contexts may not be completely identical. Two information contexts may be similar if a majority of patterns are identical between them. In the example of FIG. 6, the pattern TN in the first information context 602 is identical to the pattern T₁ in the second information context 604. Similar information contexts may represent the same information context that includes various data patterns. If a data pattern is a part of the same information context, then this pattern may have the meaning. However, if the same pattern participates in different information contexts, the meaning of this pattern may be different for different information contexts. If two information contexts are different only by two patterns, then these patterns may be similar or represent a synonymy of data patterns.

As described above, an information context represents a sequence of data patterns. Similar information contexts may have different patterns for some positions. Different data patterns on the same position of the same information context may represent the same meaning. Thus, any of these patterns may be used on this position interchangeably as a symbol of the information context's meaning. The placement of this set of patterns in a particular information context may be generalized as a position that can keep any of these patterns to represent a particular meaning. An information context with generalized position(s) may represent an abstraction or generalized notion.

FIG. 7 shows an example diagram 700 illustrating notion generalization in accordance with the present disclosure. A generalized notion is a structure that can be synthesized by placing particular data pattern(s) on generalized position(s). For example, in a set of information contexts 702, each of the information contexts may share one or more data patterns in the same position (e.g., the first and third data patterns in the example of FIG. 7). Thus, a generalized notion 704 representing the set of information contexts 702 may be created. The generalized notion 704 indicates the first and third data patterns shared by all of the information contexts in the set of information contexts 702. The second position in the generalized notion may be represented by a symbol. The generalized notion may represent a knowledge of structure and data patterns that can be used in some context to build some meaning or sense. The technique of notion generalization is an analysis capable of elaborating or deducing abstractions or notions from the input data streams without using any sophisticated algorithms. Generalized notions may be used to build a knowledge base of data structures that can be found or detected at the input data stream.

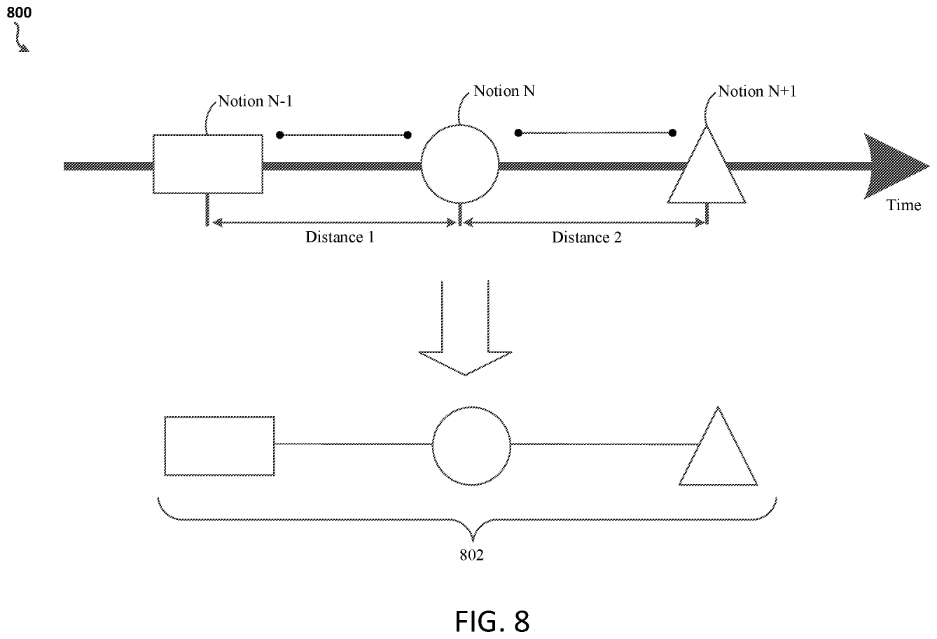

An input data stream can be imagined as a binary stream distributed in time space. It may be possible to define an input data stream as a sequence of generalized notions ordered on a time basis. FIG. 8 shows an example diagram 800 illustrating notions relation in accordance with the present disclosure. An input data stream may comprise a sequence of generalized notions (e.g., Notion N−1, Notion N, and Notion N+1 in the example of FIG. 8) ordered on a time basis. Each of Notion N−1, Notion N, and Notion N+1 may be associated with its own timestamp or location in the time dimension. Thus, Notion N−1, Notion N, and Notion N+1 are located on some distance from each other. For example, Notion N−1 and Notion N may be separated by a Distance 1, and Notion N and Notion N+1 may be separated by a Distance 2. If two or more notions are located apart multiple times, then this may indicate a repeatable relation among notions. For example, Notion N−1, Notion N, and Notion N+1 may form a repeatable notion 802. In some examples, Distance 1 and Distance 2 may be the same. In other examples, Distance 1 and Distance 2 may be different from each other.

Thus, if some set of notions is detected an information context and if there is a repetition of information context with the same set (or subset) of notions, then these notions form a relationship with each other. Additionally, or alternatively, a relation can be detected amongst information contexts. The repeatability of relations indicates reproducible data structures built by notions. Relations may be used to predict a future state(s) of an input data stream. Additionally, or alternatively, knowledge of repeatable relations may form the basis for synthesizing the data structures. For example, if some notion is detected at some position in a data stream, then the knowledge of repeatable relations facilitates the deduction of the following notions in the data stream.

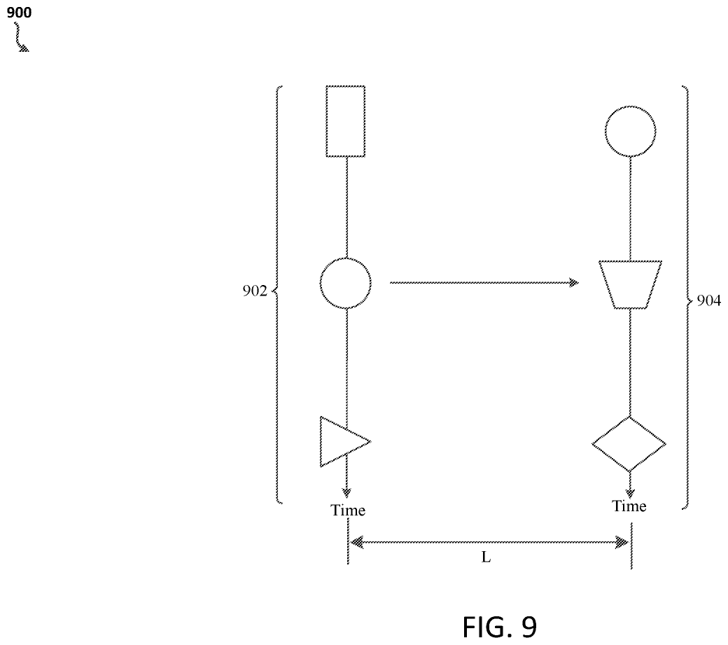

FIG. 9 shows an example diagram 900 illustrating causality relationship in accordance with the present disclosure. A relation may be a way to distinguish a reproducibility of information context. Relations may express local and reproducible links or bonds among notions. However, relations live in the time space. Thus, every relation may be associated with a timestamp or a location in the time space. Relations create a sequence that represents a causality relationship. Any event (e.g., consequence) takes place now because of some process(es) (e.g., reason) in the past. Similarly, some information context (e.g., consequence) takes place because of some information context in the past (e.g., reason). For example, an information context 904 may take place because of the information context 902 that occurred before the information context 904. If there are repetitions of reason-consequence information context pairs in the data stream, then a causality relationship between the information context pairs is detected. Knowledge of causality relationships may be utilized to predict the future state of an input data stream and to estimate the probability of every predicted notion.

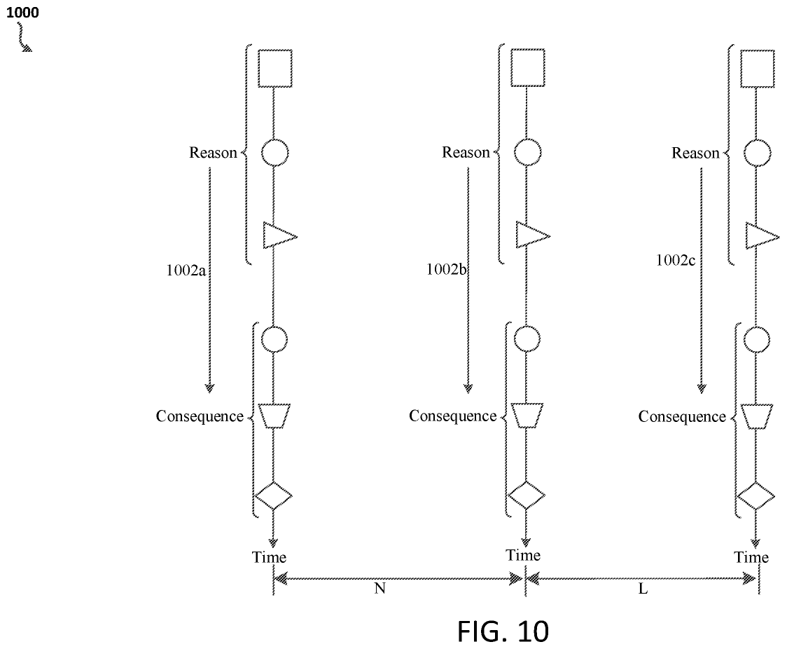

FIG. 10 shows an example diagram 1000 illustrating reproducibility of causality in accordance with the present disclosure. It may be possible to detect a first instance of an information contexts relation. However, the instance of such relation may be confirmed as a detected causality only if the repetition of this event (e.g., the reason-consequence pair) is detected multiple times. The detection of some reason-consequence information context pair in a data stream may be a coincidental event and such event may not repeat again in the future. Causality is a reproducible event that must happen multiple times. In the example of FIG. 10, the reason-consequence pair repeats itself three times (e.g., pair 1002a, pair 1002b, and pair 1002c). As the reason-consequence pair repeats itself three times, this may indicate that the relation is a detected causality.

An information contexts or notions dictionary may be built. Using the dictionary, a map of information contexts' relations with respect to the time dimension may be built. The repetition of the instances of information contexts' relations may be detected on the time map. Thus, the repeatable relations may be the causality relationship. In embodiments, the frequency (e.g., number of repetitions) of a particular causality relation may be used to predict the probability of detecting this particular causality in the future. Such probability may be calculated by dividing the frequency (e.g., number of repetitions) of a particular causality relation by the total number of known causality relations.

FIG. 11 an example diagram 1100 illustrating a time map of causality in accordance with the present disclosure. Causality implies that if some information context (e.g., reason) exists in the data stream, then another information context (e.g., consequence) may follow. A particular information context can take part in multiple causal relationships. However, there is a limited set of potential cases. Further, any causal relationship exists in a complex and multi-dimensional data space. The whole data space may represent a complex network of causal relationships. If any time point is selected, then a particular data pattern at this position exists because something has been happened in the past (or in a previous state of the data stream). Causal relationships create a network or sequence of states that end by particular data pattern or causal relation. Any reason-consequence pair (e.g., causality instance) may be located at some time point. In the example of FIG. 11, the causality instance 1102 is located at time T1 and the causality instance 1104 is located at time T2. A time map of causality that connects multiple reason consequence pairs, such as the causality instance 1102 and the causality instance 1104, into a sequence may be built. Such sequence of relations may create a formula or a statement: {[RC₁, T₁]→[RC₂, T₂]→ . . . }→[RC_{N}, T_{N}]. This statement may represent the knowledge of data pattern relationships in the form of causal relationships. Thus, the time map may provide a way to recognize and build the knowledge of complex causal relationships for the whole length of the available data stream.

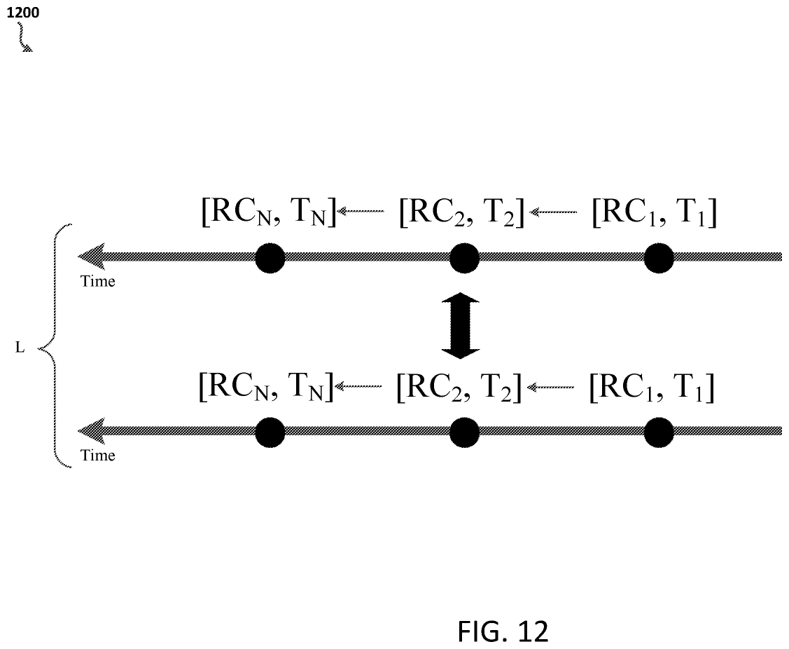

If a data stream contains some sequence of reason-consequence pairs, this does not necessarily indicate that the particular sequence represents a causal relationship. A causality time map must be reproducible. Otherwise, the sequence is pure coincidence and data noise. Thus, the same sequence of reason-consequence pairs must be found multiple times in the input data stream for converting some sequence into the knowledge of causal relationships. FIG. 12 shows an example diagram 1200 illustrating a reproducible causality time map in accordance with the present disclosure. As shown in FIG. 12, the sequence {[RC₁, T₁]→[RC₂, T₂]→. . . }→[RC_{N}, T_{N}] repeats itself (e.g., two times, three times, etc.), separated by a distance L in the time dimension. Thus, the sequence may be converted into the knowledge of causal relationships.

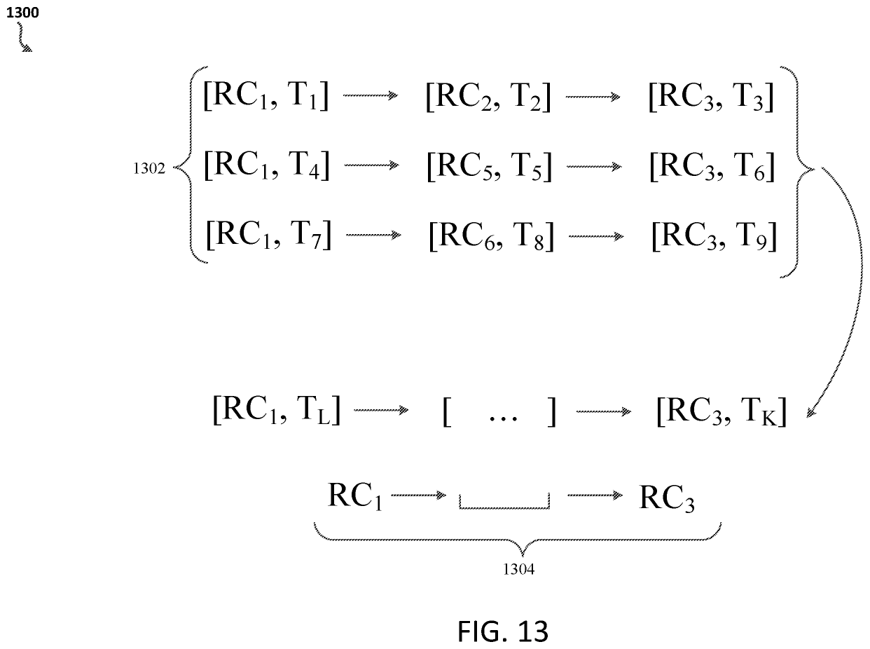

FIG. 13 shows an example diagram 1300 illustrating generalization of a causality structure in accordance with the present disclosure. A detected set of time maps 1302 does not need to contain completely identical instances. Causality time maps may be considered similar if 80%-90% of reason-consequence pairs are the same. A small portion of reason-consequence pairs in time map instances may be different from each other. The similarity between causality time maps may be the basis for generalizing the time map instances to an abstract structure 1304. The abstract structure 1304 may represent the knowledge of repeatable and reproducible causal relationships in the available data set. Such knowledge may be used to predict the presence of particular data structures in a data stream under analysis or in future states of data stream.

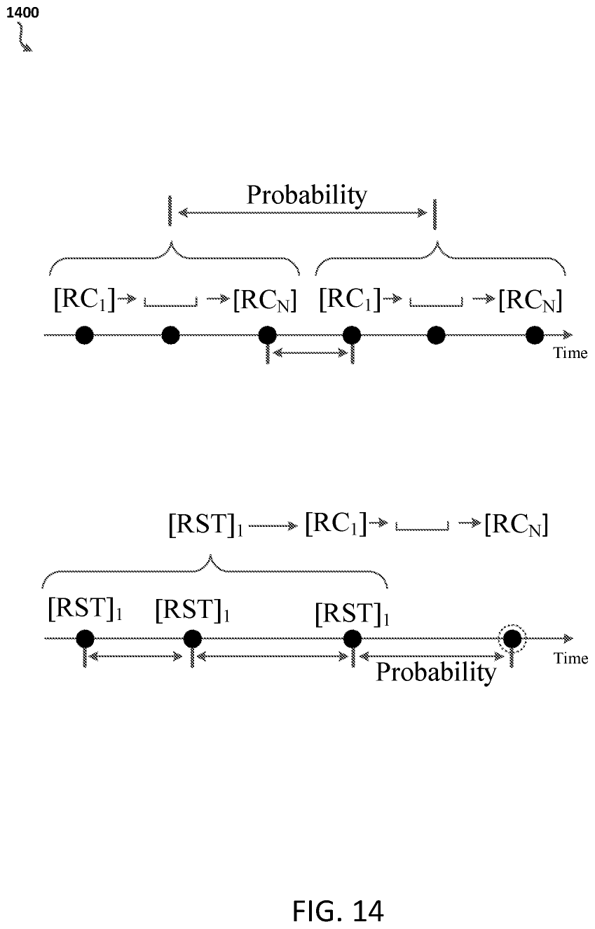

FIG. 14 shows an example diagram 1400 illustrating causal relationship prediction in accordance with the present disclosure. Predicting the presence of causal relationships or abstract structures in the future state of a data stream may be done on a probability basis. As shown in the example of FIG. 14, a probability for every known particular abstract structure may be calculated. The total number of particular instances for every abstract structure may be calculated. Finally, the probability may be calculated by dividing the total number of particular instances by the total number of all known instances of time maps. The knowledge of past states of data stream may provide the basis to estimate the probability of finding the known causal relationships in the future state of data stream.

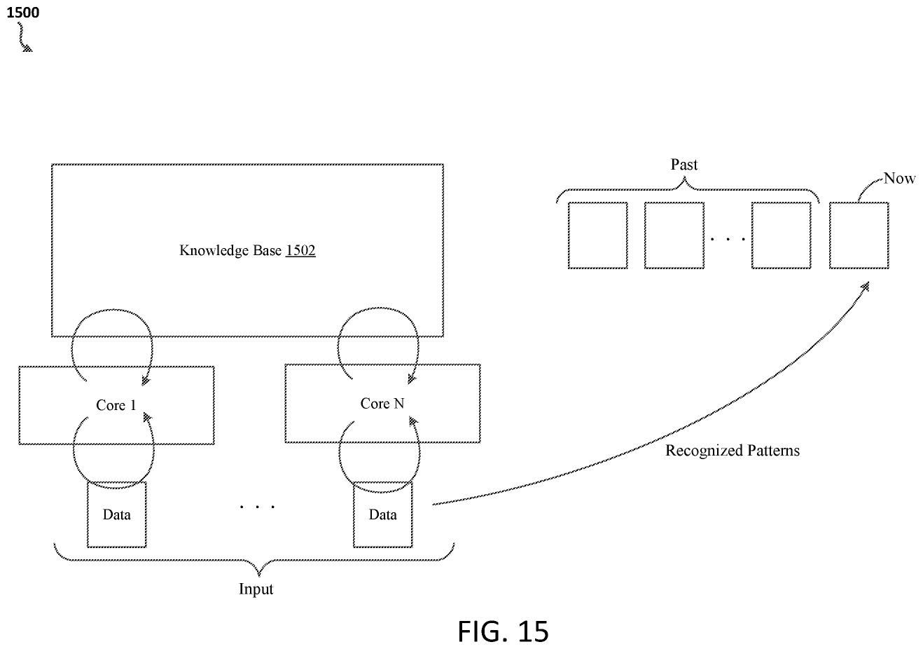

FIG. 15 shows an example architecture 1500 for pattern recognition in accordance with the present disclosure. The architecture 1500 may be configured to provide the basis for highly decentralized and massively parallel data processing. The architecture 1500 may be configured to build machine learning functional units by artificial intelligence (AI) algorithms. The initial input may be raw data (e.g., a binary stream). The architecture 1500 may be configured to recognize repeatable patterns in the input data stream. The data stream may be split on multiple portions (e.g., 4 KB memory page size) and every portion may be processed by a dedicated hardware core (e.g., Core 1-Core N) independently. The goal of this step is to recognize repeatable patterns in the memory pages and to build the knowledge of recognized patterns. The result of recognizing repeatable patterns in the input data stream may be the building of a patterns knowledge base 1502 and a sequence of information contexts with recognized data patterns. The patterns knowledge base 1502 may be used to accelerate pattern recognition and/or to make the pattern recognition more accurate. The sequence of recognized information contexts may be the input for the next step of data analysis. Hardware cores may use any algorithms or logic to recognize repeatable patterns. Additionally, or alternatively, neural networks may be used for recognition of data patterns.

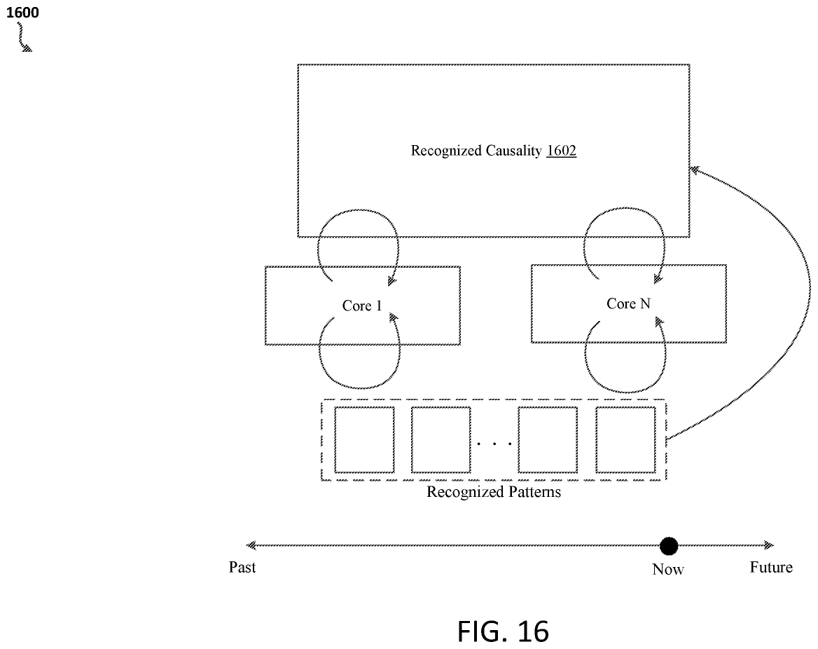

FIG. 16 shows an example framework 1600 for causality recognition in accordance with the present disclosure. If information contexts have been recognized, then causal relationships 1602 may be recognized. The recognition of causal relationships 1602 may be based on recognition of repeatability of reason-consequence pairs and/or causal time maps. Multiple cores may distribute the analyzing activity by means of parallel analysis of information contexts in the stream. The stream may represent the sequence of information contexts. Every hardware core may select a particular information context in the stream for analysis. The information contexts may be analyzed to recognize the repeatable relations of information contexts. Each particular core may detect all instances of information context's relations with other information contexts in the available data stream. Then, each core may detect the reproducibility of the detected relations. If a relation is reproducible, then it may be generalized to an abstract structure. Knowledge of abstract structures may be stored into a causality knowledge base.

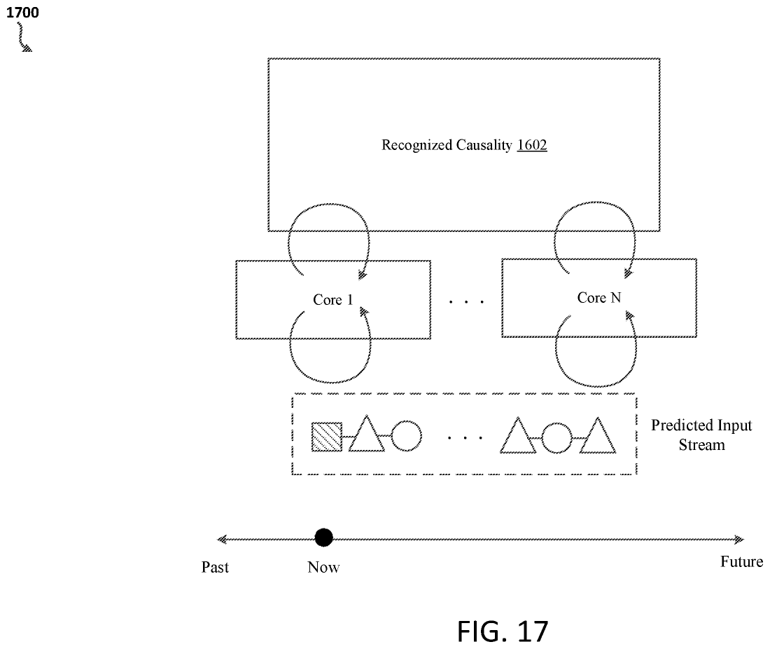

FIG. 17 shows an example diagram 1700 illustrating hypotheses generation in accordance with the present disclosure. The recognized causal relationships 1602 may be utilized to predict the future states of an input data stream. If causal relationships in the past state of the data stream are learned, then the future state of data stream may be predicted. However, the exact state of future states of an input data stream cannot be predicted. A lack of complete knowledge and multiple dimensions of potential combinations of causal relationships may limit the capability to construct or synthesize the future state of the data stream. The probability of a particular causal relationship in the future state of the data stream may be used to synthesize hypotheses of the future state the data stream.

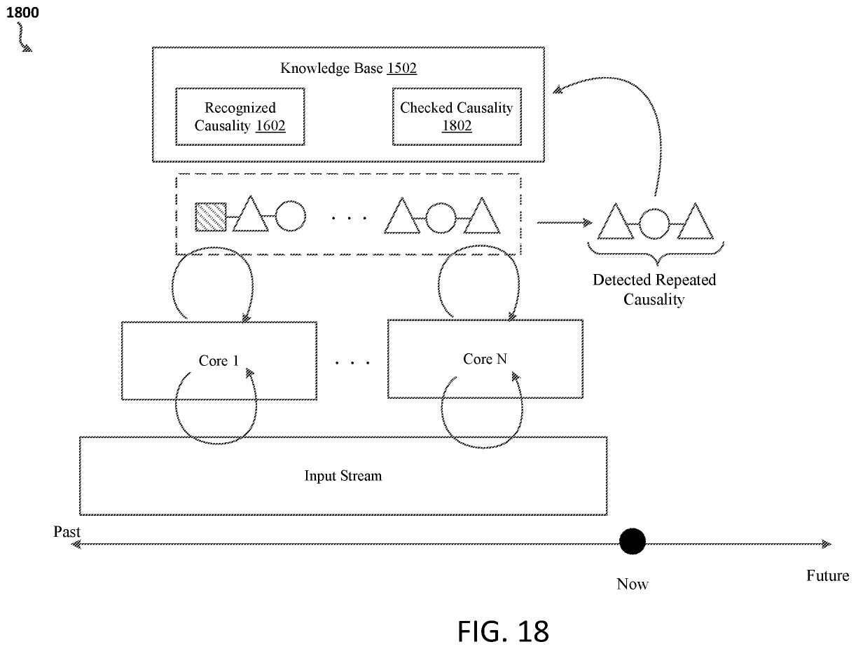

However, limited knowledge or incorrect probability estimation(s) may result in wrong hypotheses or predictions. Thus, generated hypotheses need to be checked and estimated as correct or incorrect. FIG. 18 shows an example diagram 1800 illustrating hypotheses checking in accordance with the present disclosure. A future state of data stream may be predicted on the basis of data stream state(s) in the past. The predictions may be compared with a new state of data stream that really occurs in the future. If the new state of the data stream contains the predicted data patterns or generalized notions, then the prediction may be treated as correct. In embodiments, the data stream may contain not exactly the same data patterns. If a detected data pattern represents the same generalized notion, then the prediction can be treated as partially correct. Thus, prediction may be estimated by similarity grade. Hypotheses may then be estimated as correct or not. Every particular hypothesis that represents a detected repeated causality may be treated as reliable knowledge. The recognized causality 1602 may be converted into a checked causality 1802, and it may be stored in the knowledge database 1502. In this manner, the checked causal relationships may be used as a reliable basis for building hypotheses of future states of input data streams.

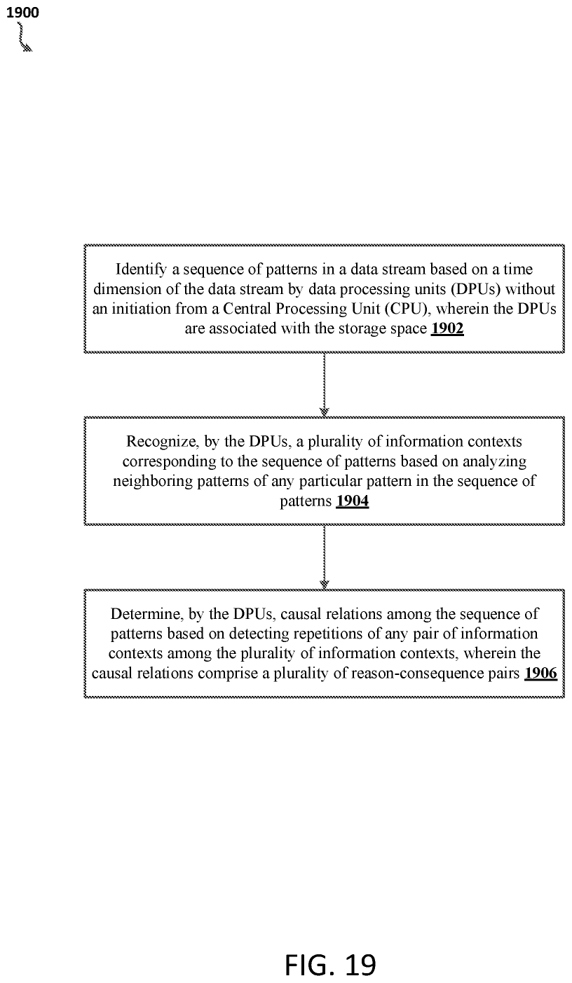

FIG. 19 illustrates an example process 1900. The process 1900 may be performed for knowledge base creation. The process 1900 may be performed by one or more components of the framework 200 depicted in FIG. 2. Although depicted as a sequence of operations in FIG. 19, those of ordinary skill in the art will appreciate that various embodiments may add, remove, reorder, or modify the depicted operations.

Any data stream may represent a sequence of patterns. At 1902, a sequence of patterns may be identified in a data stream. The sequence of patterns may be identified based on a time dimension of the data stream. The sequence of patterns may be identified by data processing units (DPUs). The DPUs may identify the sequence of patterns without an initiation from a Central Processing Unit (CPU). The DPUs may be associated with the storage space.

Any data pattern may exist in the environment of adjacent data patterns, as any data stream is a sequence that contains data patterns. A data pattern may exist in some information context. An information context is a structure composed of data patterns and the context determines the nature of a data pattern. At 1904, the DPUs may recognize a plurality of information contexts corresponding to the sequence of patterns. The plurality of information contexts may be recognized based on analyzing neighboring patterns of any particular pattern in the sequence of patterns. The information context associated with a pattern may provide value or sense to the pattern. Various information contexts may even create different senses for the same data pattern. Thus, information contexts play a fundamental role in defining a pattern's meaning. The information context may provide the basis to discover the similarity of patterns and/or to deduce or generalize particular patterns to the abstract notion. Distinguishing the information context associated with a data pattern may comprise recognizing neighboring patterns and finding a similarity with known information contexts.

A relation may be a way to distinguish a reproducibility of information context. Relations may express local and reproducible links or bonds among notions. However, relations live in the time space. Thus, every relation may be associated with a timestamp or a location in the time space. Relations create a sequence that represents a causality relationship. Any event (e.g., consequence) takes place now because of some process(es) (e.g., reason) in the past. Similarly, some information context (e.g., consequence) takes place because of some information context in the past (e.g., reason). At 1906, the DPUs may determine causal relations among the sequence of patterns. The causal relations among the sequence of patterns may be determined based on detecting repetitions of any pair of information contexts among the plurality of information contexts. The causal relations may comprise a plurality of reason-consequence pairs. If there are repetitions of reason-consequence information context pairs in the data stream, then a causality relationship between the information context pairs is detected. Knowledge of causality relationships may be utilized to predict the future state of an input data stream and to estimate the probability of every predicted notion.

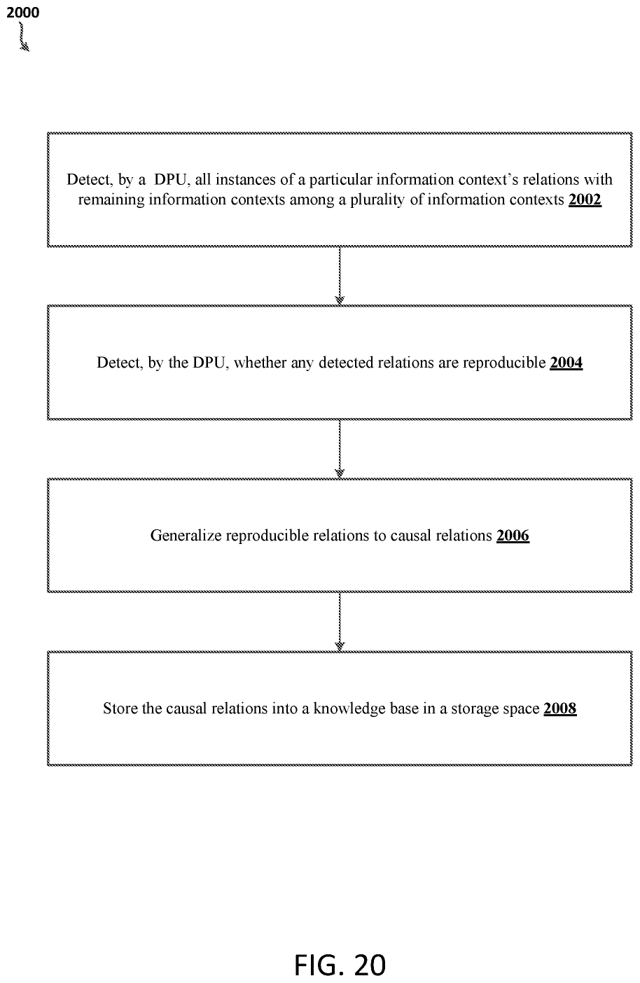

FIG. 20 illustrates an example process 2000. The process 2000 may be performed for knowledge base creation. The process 2000 may be performed by one or more components of the framework 200 depicted in FIG. 2. Although depicted as a sequence of operations in FIG. 20, those of ordinary skill in the art will appreciate that various embodiments may add, remove, reorder, or modify the depicted operations.

If information contexts have been recognized, then causal relationships may be recognized. The recognition of causal relationships may be based on recognition of repeatability of reason-consequence pairs and/or causal time maps. Multiple cores may distribute the analyzing activity by means of parallel analysis of information contexts in the stream. The stream may represent the sequence of information contexts. Every hardware core may select a particular information context in the stream for analysis. The information contexts may be analyzed to recognize the repeatable relations of information contexts. Each particular core (e.g., DPU) may detect all instances of information context's relations with other information contexts in the available data stream. At 2002, a DPU may detect all instances of a particular information context's relations with remaining information contexts among a plurality of information contexts. Then, each DPU may detect the reproducibility of the detected relations. At 2004, the DPU may detect whether any detected relations are reproducible. If a relation is reproducible, then it may be generalized to an abstract structure. At 2006, reproducible relations may be generalized to causal relations. Knowledge of abstract structures may be stored into a causality knowledge base. At 2008, the causal relations may be stored into a knowledge base in a storage space.

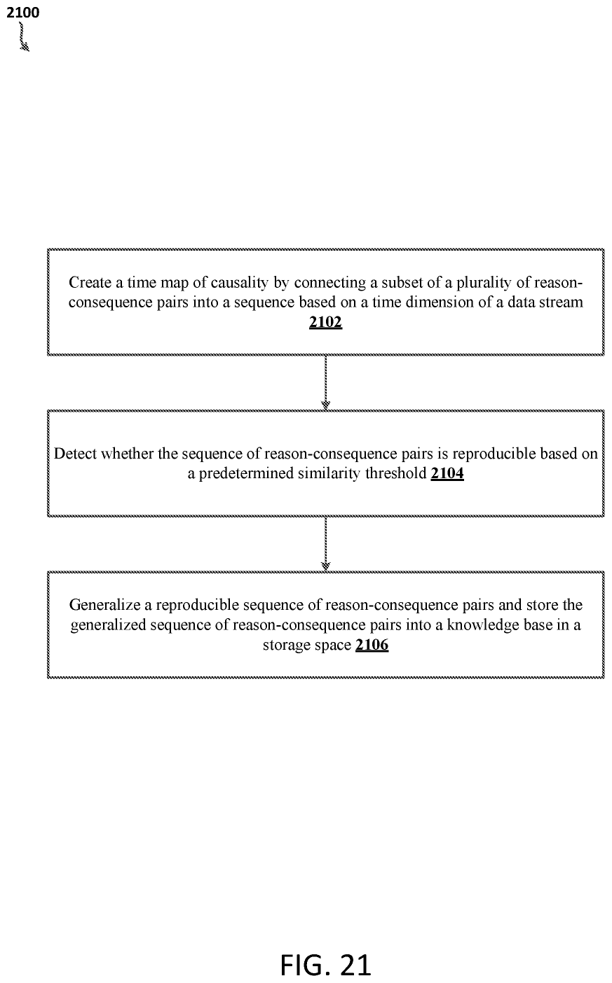

FIG. 21 illustrates an example process 2100. The process 2100 may be performed for knowledge base creation. The process 2100 may be performed by one or more components of the framework 200 depicted in FIG. 2. Although depicted as a sequence of operations in FIG. 21, those of ordinary skill in the art will appreciate that various embodiments may add, remove, reorder, or modify the depicted operations.

Causality implies that if some information context (e.g., reason) exists in the data stream, then another information context (e.g., consequence) may follow with some probability. A particular information context can take part in multiple causal relationships. However, there is a limited set of potential cases. Further, any causal relationship exists in a complex and multi-dimensional data space. The whole data space may represent a complex network of causal relationships. If any time point is selected, then a particular data pattern at this position exists because something has been happened in the past (or in a previous state of the data stream). Causal relationships create a network or sequence of states that end by particular data pattern or causal relation. Any reason-consequence pair (e.g., causality instance) may be located at some time point.

A time map of causality may connect multiple reason consequence pairs into a sequence. At 2102, a time map of causality may be created by connecting a subset of a plurality of reason-consequence pairs into a sequence. The subset of reason-consequence pairs may be connected into a sequence based on a time dimension of the data stream. For example, such sequence of relations may create a formula or a statement: {[RC1, T1]→[RC2, T2]→. . . }→[RCN, TN]. This statement may represent the knowledge of data pattern relationships in the form of causal relationships. Thus, the time map may provide a way to recognize and build the knowledge of complex causal relationships for the whole length of the available data stream.

If a data stream contains some sequence of reason-consequence pairs, this does not necessarily indicate that the particular sequence represents a causal relationship. A causality time map must be reproducible. Otherwise, the sequence is pure coincidence and data noise. Thus, the same sequence of reason-consequence pairs must be found multiple times in the input data stream for converting some sequence into the knowledge of causal relationships. At 2104, it may be detected whether the sequence of reason-consequence pairs is reproducible based on a predetermined similarity threshold and/or a frequency threshold. A detected set of time maps does not need to contain completely identical instances. Causality time maps may be considered similar if 80%-90% of reason-consequence pairs are the same. A small portion of reason-consequence pairs in time map instances may be different from each other.

The similarity between causality time maps may be the basis for generalizing the time map instances to an abstract structure. At 2106, a reproducible sequence of reason-consequence pairs may be generalized. The generalized sequence of reason-consequence pairs may be stored into a knowledge base in a storage space. The abstract structure may represent the knowledge of repeatable and reproducible causal relationships in the available data set. Such knowledge may be used to predict the presence of particular data structures in a data stream under analysis or in future states of data stream.

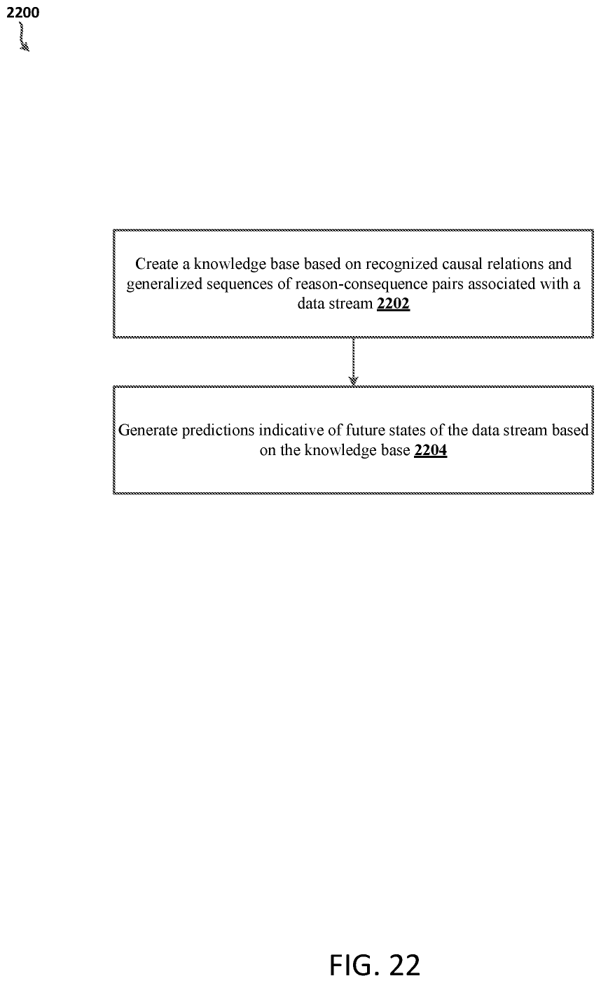

FIG. 22 illustrates an example process 2200. The process 2200 may be performed for knowledge base creation. The process 2200 may be performed by one or more components of the framework 200 depicted in FIG. 2. Although depicted as a sequence of operations in FIG. 22, those of ordinary skill in the art will appreciate that various embodiments may add, remove, reorder, or modify the depicted operations.

A smart storage device may comprise a plurality of DPUs and a huge persistent memory space. A host may be configured to store a raw binary data stream into the memory space. The write operation may operate as a request for the storage device to analyze and/or process data. The storage device may be configured to recognize patterns and relations amongst patterns in the raw data stream. The storage device may be configured to recognized causal relations and generalized sequences of reason-consequence pairs associated with the data stream. At 2202, a knowledge base may be created based on recognized causal relations and generalized sequences of reason-consequence pairs associated with a data stream. The DPU(s) may be configured to utilize this knowledge base to generate predictions indicative of future states of the data stream. At 2204, predictions indicative of future states of the data stream may be generated based on the knowledge base

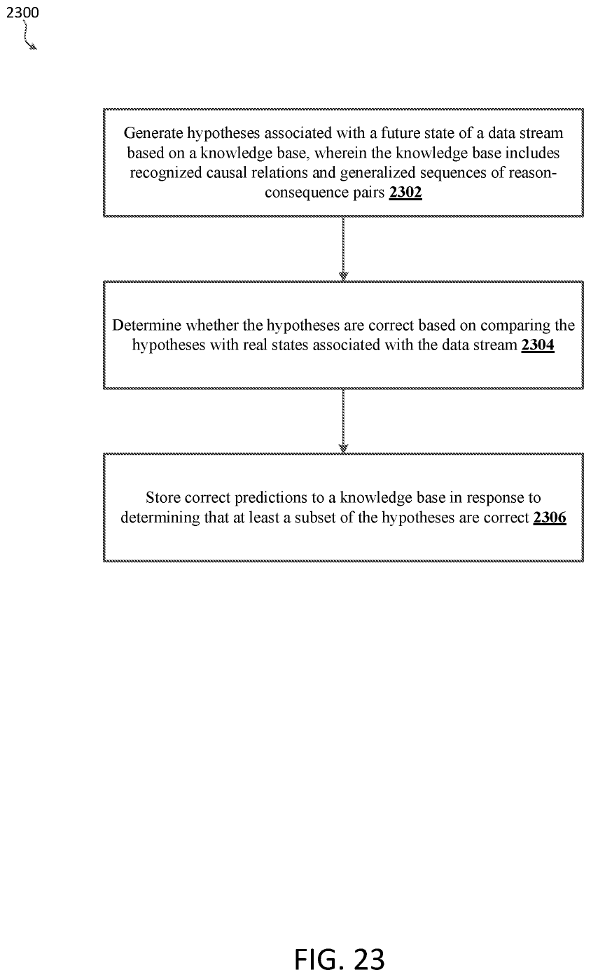

FIG. 23 illustrates an example process 2300. The process 2300 may be performed for knowledge base creation. The process 2300 may be performed by one or more components of the framework 200 depicted in FIG. 2. Although depicted as a sequence of operations in FIG. 23, those of ordinary skill in the art will appreciate that various embodiments may add, remove, reorder, or modify the depicted operations.

Limited knowledge or incorrect probability estimation(s) may result in wrong hypotheses or predictions. Thus, generated hypotheses need to be checked and estimated as correct or incorrect. The hypotheses checking logic may comprise building the hypotheses or predictions of the future state based on the past state(s) of data stream. At 2302, hypotheses associated with the data stream may be generated based on the knowledge base. The knowledge base may include recognized causal relations and generalized sequences of reason-consequence pairs. The hypotheses (e.g., predictions) may be compared with a new state of the data stream (e.g., a state that really occurs in the future). If the data stream contains the predicted data patterns or generalized notions, then the hypothesis may be treated as correct. In embodiments, the data stream may contain not exactly the same data patterns. If a detected data pattern represents the same generalized notion, then the hypothesis can be treated as partially correct. Thus, prediction may be estimated by similarity grade. Hypotheses may then be estimated as correct or not. At 2304, it may be determined whether the hypotheses are correct based on comparing the hypotheses with real future states associated with the data stream. Every particular hypothesis that represents a detected repeated causality may be treated as reliable knowledge. The recognized causality 1602 may be converted into a checked causality 1802, and it may be stored in the knowledge database 1502. In this manner, the checked causal relationships may be used as a reliable basis for building hypotheses of future states of input data streams. At 2306, correct predictions may be stored into a knowledge base in response to determining that at least a subset of the hypotheses are correct.

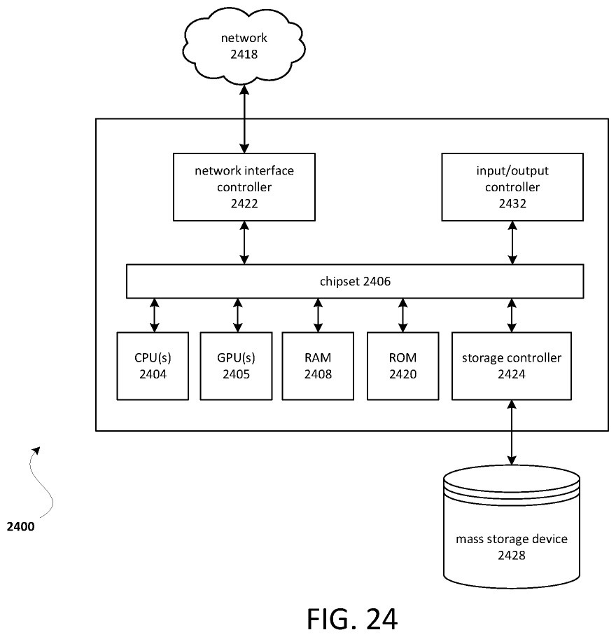

FIG. 24 illustrates a computing device that may be used in various aspects, such as the host depicted in FIG. 1. The computer architecture shown in FIG. 24 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 2400 may include a baseboard, or “motherboard,” which is a printed circuit board to which a multitude of components or devices may be connected by way of a system bus or other electrical communication paths. One or more central processing units (CPUs) 2404 may operate in conjunction with a chipset 2406. The CPU(s) 2404 may be standard programmable processors that perform arithmetic and logical operations necessary for the operation of the computing device 2400.

The CPU(s) 2404 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 2404 may be augmented with or replaced by other processing units, such as GPU(s) 2405. The GPU(s) 2405 may comprise processing units specialized for but not necessarily limited to highly parallel computations, such as graphics and other visualization-related processing.

A chipset 2406 may provide an interface between the CPU(s) 2404 and the remainder of the components and devices on the baseboard. The chipset 2406 may provide an interface to a random-access memory (RAM) 2408 used as the main memory in the computing device 2400. The chipset 2406 may further provide an interface to a computer-readable storage medium, such as a read-only memory (ROM) 2420 or non-volatile RAM (NVRAM) (not shown), for storing basic routines that may help to start up the computing device 2400 and to transfer information between the various components and devices. ROM 2420 or NVRAM may also store other software components necessary for the operation of the computing device 2400 in accordance with the aspects described herein.

The computing device 2400 may operate in a networked environment using logical connections to remote computing nodes and computer systems through local area network (LAN). The chipset 2406 may include functionality for providing network connectivity through a network interface controller (NIC) 2422, such as a gigabit Ethernet adapter. A NIC 2422 may be capable of connecting the computing device 2400 to other computing nodes over a network 2416. It should be appreciated that multiple NICs 2422 may be present in the computing device 2400, connecting the computing device to other types of networks and remote computer systems.

The computing device 2400 may be connected to a mass storage device 2428 that provides non-volatile storage for the computer. The mass storage device 2428 may store system programs, application programs, other program modules, and data, which have been described in greater detail herein. The mass storage device 2428 may be connected to the computing device 2400 through a storage controller 2424 connected to the chipset 2406. The mass storage device 2428 may consist of one or more physical storage units. The mass storage device 2428 may comprise a management component. A storage controller 2424 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 2400 may store data on the mass storage device 2428 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 2428 is characterized as primary or secondary storage and the like.

For example, the computing device 2400 may store information to the mass storage device 2428 by issuing instructions through a storage controller 2424 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 2400 may further read information from the mass storage device 2428 by detecting the physical states or characteristics of one or more particular locations within the physical storage units.

In addition to the mass storage device 2428 described above, the computing device 2400 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 2400.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 2428 depicted in FIG. 24, may store an operating system utilized to control the operation of the computing device 2400. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 2428 may store other system or application programs and data utilized by the computing device 2400.

The mass storage device 2428 or other computer-readable storage media may also be encoded with computer-executable instructions, which, when loaded into the computing device 2400, transforms the computing device from a general-purpose computing system into a special-purpose computer capable of implementing the aspects described herein. These computer-executable instructions transform the computing device 2400 by specifying how the CPU(s) 2404 transition between states, as described above. The computing device 2400 may have access to computer-readable storage media storing computer-executable instructions, which, when executed by the computing device 2400, may perform the methods described herein.

A computing device, such as the computing device 2400 depicted in FIG. 24, may also include an input/output controller 2432 for receiving and processing input from a number of input devices, such as a keyboard, a mouse, a touchpad, a touch screen, an electronic stylus, or other type of input device. Similarly, an input/output controller 2432 may provide output to a display, such as a computer monitor, a flat-panel display, a digital projector, a printer, a plotter, or other type of output device. It will be appreciated that the computing device 2400 may not include all of the components shown in FIG. 24, may include other components that are not explicitly shown in FIG. 24, or may utilize an architecture completely different than that shown in FIG. 24.

As described herein, a computing device may be a physical computing device, such as the computing device 2400 of FIG. 24. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of offloading knowledge base creation into a storage space, comprising:
identifying a sequence of patterns in a data stream based on a time dimension of the data stream by data processing units (DPUs) without an initiation from a Central Processing Unit (CPU), wherein the DPUs are associated with the storage space;
recognizing, by the DPUs, a plurality of information contexts corresponding to the sequence of patterns based on analyzing neighboring patterns of any particular pattern in the sequence of patterns; and
determining, by the DPUs, causal relations among the sequence of patterns based on detecting repetitions of any pair of information contexts among the plurality of information contexts, wherein the causal relations comprise a plurality of reason-consequence pairs.

2. The method of claim 1, further comprising:
detecting, by at least one of the DPUs, all instances of a particular information context's relations with remaining information contexts among the plurality of information contexts; and
detecting, by the at least one of the DPUs, whether any detected relations are reproducible.

3. The method of claim 2, further comprising:
generalizing reproducible relations to the causal relations; and
storing the causal relations into a knowledge base in the storage space.

4. The method of claim 1, further comprising:
creating a time map of causality by connecting a subset of the plurality of reason-consequence pairs into a sequence based on the time dimension of the data stream.

5. The method of claim 4, further comprising:
detecting whether the sequence of reason-consequence pairs is reproducible based at least in part on a predetermined similarity threshold; and
generalizing a reproducible sequence of reason-consequence pairs and storing the generalized sequence of reason-consequence pairs into a knowledge base in the storage space.

6. The method of claim 1, further comprising:
generating predictions indicative of future states of the data stream based on a knowledge base created in the storage space.

7. The method of claim 6, further comprising:
determining whether the predictions are correct based on comparing the predictions with new future states associated with the data stream; and
storing at least a subset of the predictions to the knowledge base in response to determining that the at least a subset of the predictions are correct.

8. The method of claim 7, further comprising:
generating hypotheses associated with the data stream based on the knowledge base.

9. A system, comprising:
at least one processor; and
at least one memory comprising computer-readable instructions that upon execution by the at least one processor cause the computing device to perform operations comprising:
identifying a sequence of patterns in a data stream based on a time dimension of the data stream by data processing units (DPUs) without an initiation from a Central Processing Unit (CPU), wherein the DPUs are associated with the storage space;
recognizing, by the DPUs, a plurality of information contexts corresponding to the sequence of patterns based on analyzing neighboring patterns of any particular pattern in the sequence of patterns; and
determining, by the DPUs, causal relations among the sequence of patterns based on detecting repetitions of any pair of information contexts among the plurality of information contexts, wherein the causal relations comprise a plurality of reason-consequence pairs.

10. The system of claim 9, the operations further comprising:
detecting, by at least one of the DPUs, all instances of a particular information context's relations with remaining information contexts among the plurality of information contexts; and
detecting, by the at least one of the DPUs, whether any detected relations are reproducible.

11. The system of claim 10, the operations further comprising:
generalizing reproducible relations to the causal relations; and
storing the causal relations into a knowledge base in the storage space.

12. The system of claim 9, the operations further comprising:
creating a time map of causality by connecting a subset of the plurality of reason-consequence pairs into a sequence based on the time dimension of the data stream;
detecting whether the sequence of reason-consequence pairs is reproducible based at least in part on a predetermined similarity threshold; and
generalizing a reproducible sequence of reason-consequence pairs and storing the generalized sequence of reason-consequence pairs into a knowledge base in the storage space.

13. The system of claim 9, the operations further comprising:
generating predictions indicative of future states of the data stream based on a knowledge base created in the storage space;
determining whether the predictions are correct based on comparing the predictions with new future states associated with the data stream; and
storing at least a subset of the predictions to the knowledge base in response to determining that the at least a subset of the predictions are correct.

14. The system of claim 13, further comprising:
generating hypotheses associated with the data stream based on the knowledge base.

15. A non-transitory computer-readable storage medium, storing computer-readable instructions that upon execution by a processor cause the processor to implement operations, the operation comprising:
identifying a sequence of patterns in a data stream based on a time dimension of the data stream by data processing units (DPUs) without an initiation from a Central Processing Unit (CPU), wherein the DPUs are associated with the storage space;
recognizing, by the DPUs, a plurality of information contexts corresponding to the sequence of patterns based on analyzing neighboring patterns of any particular pattern in the sequence of patterns; and
determining, by the DPUs, causal relations among the sequence of patterns based on detecting repetitions of any pair of information contexts among the plurality of information contexts, wherein the causal relations comprise a plurality of reason-consequence pairs.

16. The non-transitory computer-readable storage medium of claim 15, the operations further comprising:
detecting, by at least one of the DPUs, all instances of a particular information context's relations with remaining information contexts among the plurality of information contexts; and
detecting, by the at least one of the DPUs, whether any detected relations are reproducible.

17. The non-transitory computer-readable storage medium of claim 16, the operations further comprising:
generalizing reproducible relations to the causal relations; and
storing the causal relations into a knowledge base in the storage space.

18. The non-transitory computer-readable storage medium of claim 15, the operations further comprising:
creating a time map of causality by connecting a subset of the plurality of reason-consequence pairs into a sequence based on the time dimension of the data stream;
detecting whether the sequence of reason-consequence pairs is reproducible based at least in part on a predetermined similarity threshold; and
generalizing a reproducible sequence of reason-consequence pairs and storing the generalized sequence of reason-consequence pairs into a knowledge base in the storage space.

19. The non-transitory computer-readable storage medium of claim 15, the operations further comprising:
generating predictions indicative of future states of the data stream based on a knowledge base created in the storage space;
determining whether the predictions are correct based on comparing the predictions with new future states associated with the data stream; and
storing at least a subset of the predictions to the knowledge base in response to determining that the at least a subset of the predictions are correct.

20. The non-transitory computer-readable storage medium of claim 19, the operations further comprising:
generating hypotheses associated with the data stream based on the knowledge base.
